(19) United States
(12) Patent Application Publication
(10) Pub. No.: US 2016/0246715 A1
(43) Pub. Date: Aug. 25, 2016

(54) MEMORY MODULE WITH VOLATILE AND NON-VOLATILE STORAGE ARRAYS

(71) Applicant: Advanced Micro Devices, Inc., Sunnyvale, CA (US)

(72) Inventors: Michael Ignatowski, Austin, TX (US); Gabriel H. Loh, Bellevue, WA (US); Nuwan S. Jayasena, Sunnyvale, CA (US)

(21) Appl. No.: 14/628,699

(22) Filed: Feb. 23, 2015

(51) Int. Cl. G06F 12/08; G06F 12/10; G06F 3/06

(52) U.S. Cl. CPC G06F 12/0802; G06F 3/0611; G06F 3/0647; G06F 3/0685; G06F 12/1009; G06F 3/0619; G06F 2212/1024

(57) ABSTRACT

A memory module is responsive to control signaling for a random access memory (RAM) module, and performs translation of received memory addresses so that it can map a relatively small address space of an operating system to a larger physical address space of its storage arrays. The memory module can therefore be employed in systems requiring a large amount of memory, such as systems using many processors, without requiring specialized operating systems for addressing the larger physical address space.

### BACKGROUND

1. Field of the Disclosure

The present disclosure relates generally to processing systems and more particularly to memory modules for processing systems.

2. Description of the Related Art

To simplify the design and production of application programs, modern processing systems typically employ a memory management technique that isolates the application programs from the physical memory modules of the processing system. An operating system (OS) of the processing system assigns each executing application a set of virtual memory addresses to be used by the application for data storage and retrieval. The OS maintains a set of page tables that maps the virtual memory addresses to physical addresses of the memory modules of the processing system. In response to a memory access request by an application, a processor's memory management unit (MMU) employs the page tables to translate the request's virtual address to a physical address, and the processor executes the memory access request at the physical address. However, address translation by the MMU can require several steps, including comparison of the virtual address to recently translated addresses in a translation look-aside buffer (TLB), retrieval of page tables from memory, and replacement of data in the TLB. For modern processing systems that employ a large number of processors and a large physical memory capacity, the latency introduced by these steps can have a significant impact on the performance of the processing system.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system employing a memory module having heterogeneous storage arrays in accordance with some embodiments.

FIG. 2 is a block diagram illustrating additional aspects of the memory module of FIG. 1 in accordance with some embodiments.

FIG. 3 is a diagram illustrating translation of a virtual address at the processing system of FIG. 1 in accordance with some embodiments.

FIG. 4 is a flow diagram of a method of processing a memory access request at the memory module of FIG. 1 in accordance with some embodiments.

FIG. 5 is a flow diagram illustrating a method for designing and fabricating an integrated circuit device implementing at least a portion of a component of a processing system in accordance with some embodiments.

### DETAILED DESCRIPTION

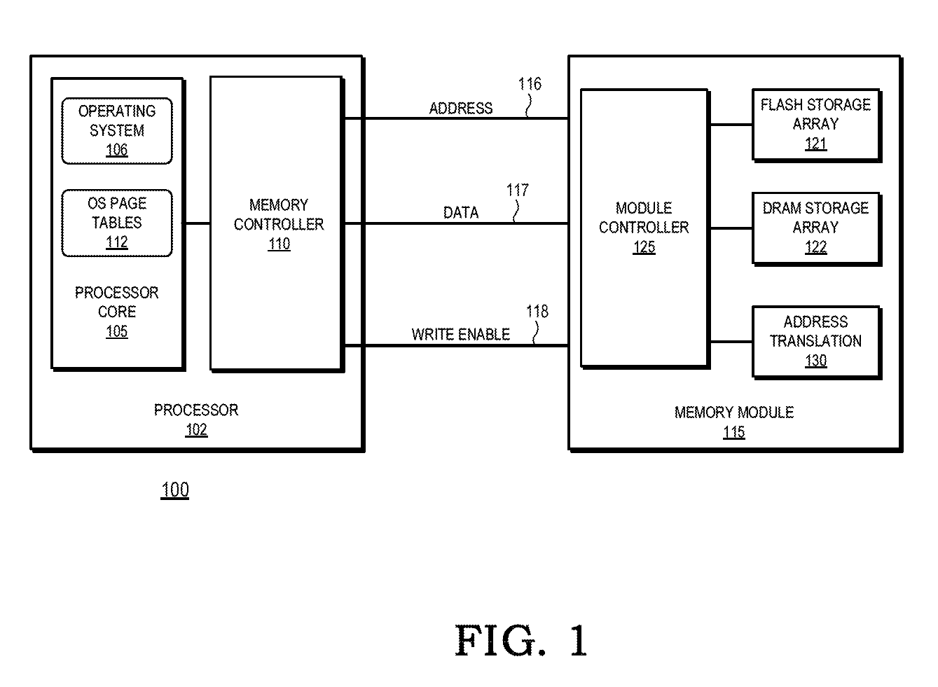

FIGS. 1-5 illustrate techniques associated with and embodiments of a memory module that includes multiple heterogeneous memory arrays and an embedded memory controller to manage storage and retrieval of data at the memory arrays. The memory module is responsive to control signaling formatted in accordance with a random access memory (RAM) protocol so that the memory module can be accessed by a processor as though the memory module were a conventional RAM array. without redesign of the processor or the operating system executed at the processor. Further, the memory module can perform translation of received memory addresses so that it can map a relatively small address space of an operating system to a larger physical address space of its storage arrays, which, in some embodiments, share a common unified memory address space. The memory module can therefore be employed in systems requiring a large amount of memory, such as systems using many processors, without requiring specialized operating systems for addressing the larger physical address space.

For example, in at least one embodiment the memory module includes a flash memory storage array, a dynamic random access memory (DRAM) storage array, a memory controller, and an address translation module. The memory module receives memory access requests from a processor via control signaling formatted according to a standard DRAM interface. Each memory access request includes a physical address that has been translated from a virtual address at the processor. In some embodiments, the physical address is the address obtained based on a set of page tables of an OS executing at the processor according to conventional memory management techniques. The address translation module at the memory module stores a mapping of physical addresses to storage addresses for the storage arrays. In response to receiving a memory access request, the address translation module translates the received physical address to a corresponding storage address based on the mapping, and the memory controller executes the memory access request at the indicated storage address. For a given memory access request, the memory module can access either of the different storage arrays depending on which storage array is mapped to the address of the memory access request. Further, the memory module can move data between the storage arrays based on access patterns in the memory access requests. For example, the memory module can ensure that data likely to be accessed is stored at the DRAM array. The memory module thereby emulates the operations and access speed of a DRAM memory module while effectively having the larger physical address space of the flash memory storage array.

FIG. 1 illustrates a processing system 100 in accordance with at least one embodiment of the present disclosure. The processing system 100 is generally configured to execute sets of instructions (e.g., computer programs) that manipulate data in order to carry out tasks specified by the sets of instructions. The processing system 100 can be incorporated into any of a variety of electronic devices, including a desktop or laptop computer, server, cellphone, electronic tablet, set-top box, game console, and the like.

The processing system 100 includes a processor 102 connected to a memory module 115 via signal lines 116, 117, and 118. Although illustrated with a single processor 102 for ease of description, it will be appreciated that in some embodiments the processing system 100 can include additional processors and additional memory modules. In some embodiments, the processor 102 is a general purpose processor that executes sets of instructions (e.g., computer programs) to carry out tasks specified by the sets.

The processor 102 includes a processor core 105 and a memory controller 110. The processor core can be a central processing unit (CPU), graphics processing unit (GPU), digital signal processor (DSP), field programmable gate array (FPGA), and the like. The processor core 105 includes an instruction pipeline and other associated circuitry to execute the sets of instructions for the processor 102. In some embodiments, the processor 102 includes additional circuitry, not specifically illustrated at FIG. 1, to facilitate efficient execution of instructions, including one or more caches, input/output (I/O) interfaces, memory coherency managers, and the like. In the course of executing instructions the processor core generates operations, referred to as memory access requests, to access data. Examples of memory access requests include read requests to retrieve data and have it provided to a register of the processor core 105, and write requests to have a data payload (the write data) of the write request written to a storage location. Each memory access request includes a memory address indicating the storage location targeted by the memory access request.

The memory controller 110 is generally configured to receive memory access requests from the processor core 105 and to generate control signaling to facilitate those requests. The memory controller 110 can also perform additional operations, including buffering of memory access requests and responses thereto, and the like. In response to receiving a memory access request including an address indicating the storage location targeted by the request, the memory controller 110 provides the address on address signal line 116. If the memory access request is a write request, the memory controller 110 provides the write data on data signal line 117. In addition, the memory controller 110 indicates the type of request via a signal provided on write enable line 118 (e.g., an asserted signal to indicate a write request and a negated signal to indicate a read request). It will be appreciated that although signal lines 116, 117, and 118 are depicted as single lines for ease of illustration, in some embodiment one or more of the illustrated signal lines can represent a bus having multiple signal lines. For example, in some embodiments each of the signal lines 116 and 117 can be an 8-bit bus that can carry eight bits of information in parallel. In addition, in some embodiments the memory controller 110 can provide additional control signaling (e.g., one or more clock signals) to the memory module 115 via signal lines not illustrated at FIG. 1.

The memory module 115 includes a flash storage array 121, a DRAM storage array 122, a module controller 125, and an address translation module 130. The flash storage array 121 is a non-volatile storage array of flash memory cells, such as NAND flash or NOR flash memory. The DRAM storage array 122 is a storage array of DRAM cells. In some embodiments, the flash storage array 121 is denser (includes more storage locations per unit of area) than the DRAM storage array 122, but has slower access speeds than the than the DRAM storage array 122. In some embodiments the storage array 121 and storage array 122 can be different types of memory other than DRAM and flash, respectively. For example, in some embodiments, the storage array 122 is a non-volatile storage array of a first type and the storage array 121 is a non-volatile storage array of a different type that responds to memory accesses more slowly than the storage array 122.

The module controller 125 is generally configured to receive control signaling via the signal lines 116-118 representing a memory access request, identify the storage locations of one or more of the flash storage array 121 and DRAM storage array 122 targeted by the request, and to fulfill the memory access request at the identified storage location. For example, in the case of a write request the module controller 125 writes the write data to the targeted storage location. In the case of a read request the module controller 125 retrieves the data at the indicated storage location and provides the retrieved data on the data signal line 117.

In some embodiments, the processing system 100 employs at least three different memory address spaces to facilitate efficient execution of instructions and efficient storage of data. These memory address spaces include a virtual address space, employed by programs executing at the processor core 105; an physical address space, employed by an operating system to assist the executing programs in accessing memory locations; and a storage address space employed by the memory module 115 to identify the physical storage locations at the storage arrays 121 and 122 that store data. The address translation module 130 is generally configured to translate addresses from the physical address space to the storage address space. By separating the physical address space from the storage address space using the address translation module 130, the memory module 115 can provide the memory density of the flash storage array 121 with the access speeds of the DRAM storage array 122, as described further herein.

In operation, the processor core 105 generates a memory access request including a virtual address (a memory address in the virtual address space) indicating the storage location targeted by the memory access request. An memory management unit (MMU) (not shown) associated with the processor core 105 employs OS page tables 112 to translate the virtual address to a physical address (a memory address in the physical address space). The OS page tables 112 represent a mapping of the virtual address space to the physical address space. As used herein, the term “page table” refers to any data structure that stores address translation information to translate addresses from one address space to another. In some embodiments, the processor core 105 includes additional circuitry, not illustrated at FIG. 1, to facilitate translation of virtual addresses to physical addresses. For example, the processor core 105 can include a translation lookaside buffer (TLB) that includes the physical addresses for sets of recently accessed virtual addresses, and a page walk module to efficiently access the page tables 112. In response to receiving a virtual address, the processor core accesses the TLB to determine if it includes the virtual address and, if so, identifies the physical address from the TLB. If the TLB does not include the virtual address, the MMU uses the page walk module to identify the physical address and stores the physical address and virtual address at the TLB.

In some embodiments, the OS page tables 112 are generated and managed by an OS 106 executed at the processor core 105. The OS 106 can manage the OS page tables 112 using conventional memory management techniques. For example, in response to a computer program beginning execution at the processor core 105, the computer program can request a specified amount of virtual memory space. In response the OS 106 identifies a set of virtual addresses (the virtual address space) representing the requested virtual memory space, and identifies a set of unused physical addresses (the physical address space) for the virtual memory space. The OS 106 generates a mapping between the virtual address space and the physical address space and updates the OS page tables to include the generated mapping.

After generating the physical address, the memory controller provides the physical address at the address signal line 116. The module controller 125 employs the address translation module 130 to translate the physical address to a storage address. In some embodiments, the address translation module 130 employs page tables, referred to as memory module (MM) page tables and different from the page tables 112, to translate the physical address to the storage address. The MM page tables are managed by the module controller 125 independently of the OS page tables 112. This allows the memory module 115 to move data between the flash storage array 121 and the DRAM storage array 122 so that the transfers are transparent to the OS 106. The memory module 115 can thus provide the density of the flash storage array 121 and access speeds of the DRAM storage array 122 without management by the OS 106, thereby increasing processing efficiency.

In some embodiments, the control signaling provided by the memory controller 110 via the signal lines 116-118 is formatted for accessing a conventional RAM memory module (e.g., a double data rate type three (DDR3) or double data rate type four (DDR4) memory module. That is, the signal voltage levels, signal timing, signal encoding, and the like between the processor 102 and the memory module 115 are formatted for accessing a RAM memory module. This allows the memory module 115 to be used in processing systems design for use with conventional RAM modules without extensive redesign of the systems.

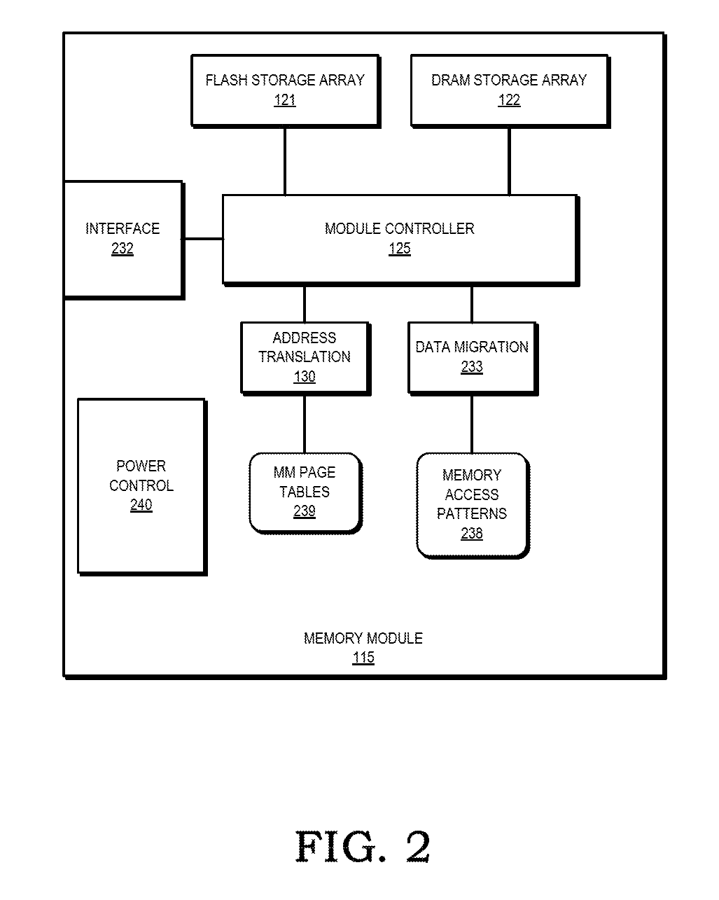

FIG. 2 illustrates additional aspects of the memory module 115 in accordance with some embodiments. In the depicted example, the memory module 115 includes the flash storage array 121, the DRAM storage array 122, the module controller 125, and the address translation module 130. In addition, the memory module 115 includes an interface 232, a data migration module 233, and a power control module 240. The interface 232 provides an interface between the module controller 125 and the processor 102. Accordingly, the interface 232 can perform functions such as signal acquisition and identification, buffering, clock and timing interfacing, and the like to ensure that the module controller 125 receives addresses, data, and other control signaling from the processor 102 in a format usable by the module controller 125. In some embodiments, the interface 232 also ensures that signals provided to the processor 102 by the memory module 115 are formatted to match signaling of a conventional RAM memory module. That is, the interface 232 is configured to allow the processor 102 to interact with the memory module 115 as it would interact with a RAM memory module.

The address translation module 130 is configured to translate received addresses from the physical address space to the storage address space that indicates physical storage locations of the storage arrays 121 and 122. To facilitate translation, the address translation module 130 employs MM page tables 239, which represent a mapping of the physical address space to the storage address space of the memory module 115. In some embodiments, the MM page tables 239 are generated and managed by the memory module 115. For example, in some embodiments the module controller 125 generates the MM page tables 239 in response to a system reset to match storage addresses of the storage arrays 121 and 122 to a specified physical address space. The MM page tables 239 can be stored at either of the storage arrays 121 and 122 or at a different storage array (not shown) such as a separate static RAM (SRAM) array.

As described further herein, the module controller 125 can transfer data (also referred to as “migrating data” between the flash storage array 121 and the DRAM storage array 122, or between locations within each of the storage arrays 121 and 122, to achieve one or more specified objectives, including specified quality-of-service (QOS) levels for one or more executing computer programs, data redundancy and security, memory access speed requirements, and the like. As data is migrated between the flash storage array 121 and the DRAM storage array 122, the module controller 125 updates the MM page tables 239 to indicate which physical storage location of the flash storage array 121 and the DRAM storage array 122 stores data corresponding to a physical address.

To illustrate via an example, a given set of data, corresponding to a given physical address, can be stored at a given physical location of the flash storage array 121. Accordingly, the MM page tables 239 are generated to map the physical address for the data to the storage address of the physical location of the flash storage array 121. Subsequently, the module controller 125 transfers the data to a physical location of the DRAM storage array 122 in order to achieve a specified objective, such as a specified level of memory access speed for the data. In response, the module controller 125 updates the MM page tables 239 to indicate the physical location of the DRAM storage array 122 that now stores the data. If the data is later evicted from the DRAM storage array 122 and returned to the flash storage array 121, the module controller 125 can update the MM page tables 239 to indicate the most up-to-date physical location of the data at the storage arrays 121 and 122.

Because the module controller 125 can transfer data between the storage arrays 121 and 122 (and between storage locations within each of the storage arrays 121 and 122) independently of the OS 106, it can efficiently perform different functions to enhance storage reliability and efficiency of access. For example, in some embodiments the module controller 125 can perform fault detection and repair operations wherein it identifies faulty memory cells at the storage arrays 121 and 122 and migrates data at those cells to other storage locations, including updating the MM page tables 239 to reflect the transfer. The module controller 125 can perform other operations, including error detection and correction (e.g., ECC) for received memory access requests, data compression and data encryption, other data security functions, virtualization functions such as partitioning different portions of the storage array for different programs, processors, or processor cores, ensuring QOS guarantees for different programs, processors, or processor cores are met, and the like.

The data migration module 233 monitors memory access requests received and executed at the module controller 125 and identifies patterns, designated memory access patterns 238, in the monitored requests. In some embodiments, the data migration module 233 employs the memory access patterns to transfer data between the storage arrays 121 and 122 to enhance memory access speeds for the memory module 115. For example, the data migration module 233 can use conventional prefetch algorithms to identify data stored at the flash storage array 121 that is expected to be accessed in the near future, and to transfer the identified data to the DRAM storage array 122 for faster access. The data migration module 233 can also employ data replacement algorithms to transfer data that is unlikely to be accessed in the near future from the DRAM storage array 122 to the flash storage array 121. In response to the data migration module 233 transferring data between the storage arrays 121 and 122, the module controller 125 updates the MM page tables 239 to reflect the most up-to-date physical storage location of the data, as described above.

The power control module 240 is generally configured to set a power mode of the memory module 115 based on module activity. In some embodiments, the memory module 115 can be placed in any of a plurality of power modes, including an inactive mode wherein the memory module 115 retains stored data but does not execute memory access requests, and one or more responsive power modes. In each of the responsive power modes the memory module 115 can respond to memory access requests at a particular response speed, consuming a commensurate amount of power. For example, in a faster responsive mode, the memory module 115 consumes more power. In some embodiments, the power control module 240 monitors an activity level at the memory module 115 based on one or more criteria, such as a number of memory access requests buffered at the module controller 125, an amount of memory access requests expected to be received at the memory module 115, and the like. Based on the activity level, the power control module 240 can set the power mode of the memory module 115 to comply with a specified power management policy of the processing system 100. The power control module 240 can set the power mode of the memory module 115 independently of any power management at the processor 102, thereby reducing processor overhead. In some embodiments, the power control module 240 can also set the power mode of the memory module 115 in response to control signaling received from another module, such as the processor core 105.

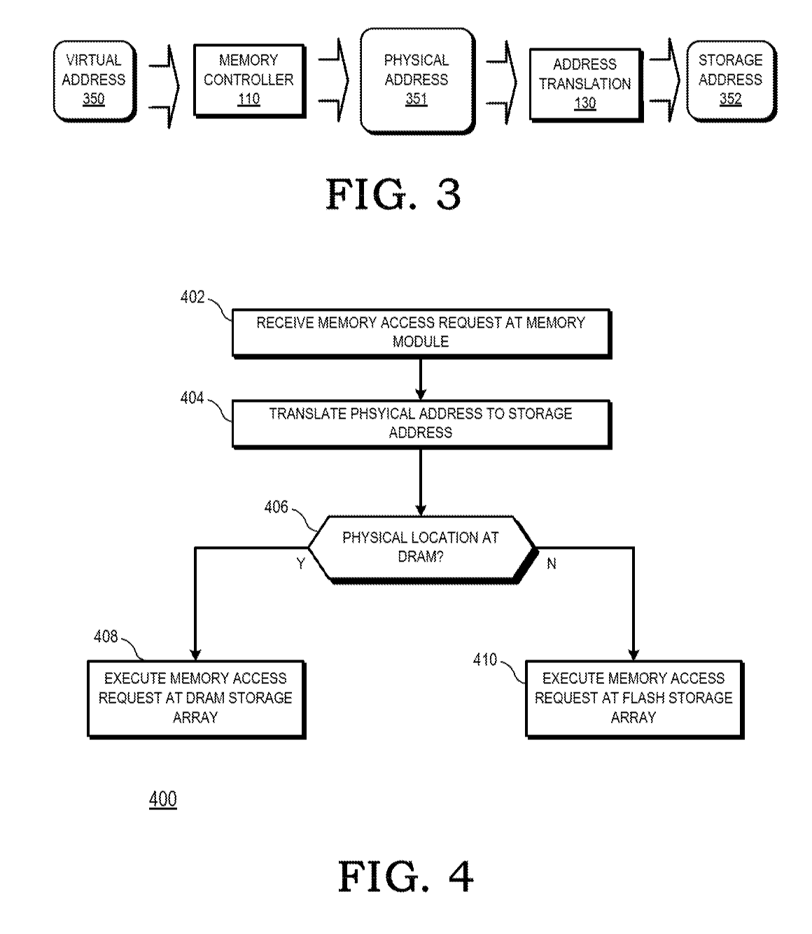

FIG. 3 is a diagram illustrating translation of a virtual address at the processing system of FIG. 1 in accordance with some embodiments. A memory access request including a virtual address 350 is received at the memory controller 110. The memory controller 110 employs the OS page tables 112 to translate the virtual address 350 to a physical address 351. The module controller 125 provides the physical address 351 to the memory module 115 via the address signal line 116. The address translation module 130 of the memory module 115 translates the physical address to a storage address 352 using the MM page tables 239. The module controller 125 uses the storage address 352 to identify a physical location of one of the flash storage array 121 and the DRAM storage array 122 and performs the requested memory access at the identified physical location.

FIG. 4 illustrates a flow diagram of a method 400 of processing a memory access request at the memory module 115 in accordance with some embodiments. At block 402 the memory module 115 receives a memory access request via control signaling provided over the signal lines 116-118. At block 404 the address translation module 130 translates the physical address of the received memory access request to a storage address using the MM page tables 239. At block 406 the module controller 125 determines if the storage address indicates a storage location of the DRAM storage array 122. If so, the method flow moves to block 408 and the module controller 125 generates control signaling to execute the memory access request at the indicated storage location of the DRAM storage array 122. Returning to block 406, if the module controller 125 determines that the storage address indicates a storage location of the flash storage array 121, the method flow moves to block 410 and the module controller 125 generates control signaling to execute the memory access request at the indicated storage location of the flash storage array 121.

In some embodiments, the apparatus and techniques described above are implemented in a system comprising one or more integrated circuit (IC) devices (also referred to as integrated circuit packages or microchips), such as the memory module described above with reference to FIGS. 1-4. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

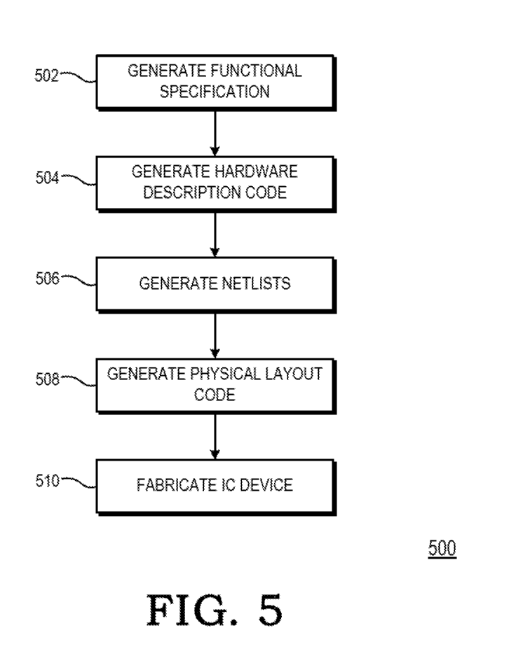

FIG. 5 is a flow diagram illustrating an example method 500 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 502 a functional specification for the IC device is generated. The functional specification (often referred to as a micro architecture specification (MAS)) may be represented by any of a variety of programming languages or modeling languages, including C, C++, SystemC, Simulink, or MATLAB.

At block 504, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 506 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 508, one or more EDA tools use the netlists produced at block 506 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 510, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A memory module comprising:
a volatile storage array;
a non-volatile storage array;
an interface to receive control signaling indicative of a memory access request, the control signaling formatted for accessing a random access memory (RAM) memory module; and
a controller to access one of the volatile storage array and the non-volatile storage array based on a first memory address of the memory access request.

2. The memory module of claim 1, further comprising:
an address translation module to translate the first memory address to a second memory address.

3. The memory module of claim 2, wherein the first memory address is a physical address and the second memory address is a storage address of a storage location of the one of the volatile storage array and the non-volatile storage array.

4. The memory module of claim 2, further comprising:
a data migration module to transfer data between the volatile storage array and the non-volatile storage array.

5. The memory module of claim 4, wherein the data migration module is to transfer data between the volatile storage array and the non-volatile storage array based on access patterns indicated by a plurality of memory access requests received via the interface.

6. The memory module of claim 4, wherein the address translation module updates a set of stored page tables based on the data migration module transferring data between the volatile storage array and the non-volatile storage array.

7. The memory module of claim 1, further comprising:
a power control module to change a power mode of the memory module based on a measured activity level at the memory module.

8. The memory module of claim 1, wherein the controller is to perform fault detection and repair for the volatile storage array and the non-volatile storage array.

9. The memory module of claim 1, wherein the controller is to perform data compression for data to be stored at one of the volatile storage array and the non-volatile storage array.

10. A memory module comprising:
a volatile storage array;
a non-volatile storage array;
an interface to receive a memory access request comprising a first address;
an address translation module to translate the first address to a second address; and
a controller to access one of the volatile storage array and the non-volatile storage array based on the second address.

11. The memory module of claim 10, further comprising:
a data migration module to transfer data between the volatile storage array and the non-volatile storage array.

12. The memory module of claim 11, wherein the data migration module transfers data between the volatile storage array and the non-volatile storage array based on access patterns indicated by a plurality of memory access requests received via the interface.

13. The memory module of claim 12, wherein the address translation module updates a set of stored page tables based on the data migration module transferring data between the volatile storage array and the non-volatile storage array.

14. The memory module of claim 10, further comprising:
a power control module to change a power mode of the memory module based on a measured activity level at the memory module.

15. A method, comprising:
receiving, at a memory module of a processing system, control signaling indicative of a memory access request, the control signaling formatted for accessing a random access memory (RAM) module; and
accessing one of a volatile storage array and a non-volatile storage array of the memory module based on a first memory address of the memory access request.

16. The method of claim 15, further comprising:
translating at the memory module the first memory address to a second memory address.

17. The method of claim 16, wherein the first memory address is an address indicated as a physical address on a page table of an operating system that initiated generation of the control signaling.

18. The method of claim 17, wherein the second memory address is a physical address of a storage location of the one of the volatile storage array and the non-volatile storage array.

19. The method of claim 15, further comprising:
transferring data between the volatile storage array and the non-volatile storage array.

20. The method of claim 19, wherein transferring data between the volatile storage array and the non-volatile storage array comprises transferring the data based on access patterns indicated by a plurality of memory access requests received at the memory module.
